(19) United States
(12) Patent Application Publication
(10) Pub. No.: US 2007/0104467 A1
(43) Pub. Date: May 10, 2007

(54) Portable player for videodisc with a screen which can rotate in upturn and/or turn around

(76) Inventors: Shaocheng Wang, Fujian Province (CN); Mingbiao Huang, Fujian Province (CN); Jianrong Lai, Fujian Province (CN); Zhihai Wen, Fujian Province (CN); Denghai Zeng, Fujian Province (CN)

Correspondence Address: GREER, BURNS & CRAIN, 300 S WACKER DR, 25TH FLOOR, CHICAGO, IL, 60606, US

(21) Appl. No.: 10/565,603

(22) PCT Filed: Sep. 15, 2003
(86) PCT No.: PCT/CN03/00775

§ 371 Date: Sep. 12, 2006

(30) Foreign Application Priority Data
Jul. 25, 2003 (CN) 03271380.0

(51) Int. Cl. H04N 5/00

(52) U.S. Cl. 386/125

(57) ABSTRACT

A portable videodisc player with a screen which is axially and upwardly rotatable. The player has a screen, which is rotatable within 180 degrees relative respectively to the vertical and horizontal axes. The player has a main body having a disc driver and a disc information read/processor, and a display cover board having a screen. An upturn hinge is found at an edge of the main body and an edge of the display cover board. A cable connects the main body and the display cover board. The main body of the upturn hinge is a T-shaped cannula. A horizontal end of the cannula is fixed on the side of the display cover board and is a shaft having a damper. A vertical end is used as a rotation shaft which is mounted on the main body. A cable passes through the inner hole of the main body of the upturn hinge to connect the main body of the player and the display cover board.

### FIELD OF THE NVETION

The present invention generally relates to a video disc player, and more particularly, to a portable player for videodisc with a screen which can rotate in upturn and/or turn around.

### BACKGROUND OF THE INVENTION

A portable video disc player suitable for family and journey use generally comprises a main body including a disc driving device and a disc reading and processing device, and a display cover having a display screen; a side edge of the main body and a side edge of the display cover both have transverse pin joint devices; there are cable connections between the main body and the display cover board. When used, the display cover board is pivoted upwards from a horizontally covering position in which the display cover board covers the main frame to an upright position and a disc is inserted into the main body, then a video can be played. In journey, especially in cars, trains or on the steamships, because of the limitation of the space, in order to obtain the optimum visual effect, people hope that the display cover board can rotate relatively to the upper surface of the main body into a certain angle in which the screen is suit for watching; the portable video disc player mentioned above obviously can not satisfy people's demand.

### BRIEF SUMMARY OF THE INVENTION

The present invention is to provide a portable player for videodisc with a screen which can rotate in upturn and/or turn around which enables the screen to reverse/rotate along horizontal/longitudinal axis of the upper surface of the main body within 180 degrees.

The object of the invention is accomplished in the following scheme: A portable player for videodisc with a screen which can rotate in upturn and/or turn around, including a main body comprising a disc driver means and a disc information read/processing means and a display cover board with a display screen; an upturn hinge means is set at a side edge of the main body and a side edge of the display cover board; a cable connects between the main body and the display cover board; wherein the main body of the upturn hinge means is T shaped cannula, the horizontal end of the cannula is fixed on the side of the display cover board and is a shaft having a damper; the vertical end is used as a rotation shaft which is mounted on the main body; a cable across through the inner hole of the main body of the upturn hinge means to make the main body of the player and the display cover board connected; the display cover board can rotate within 180 degrees relatives to the vertical axes and the horizontal axes of its main body respectively.

There is a recess in the centre of the rear end of the display cover board; the horizontal end of the body of the upturn hinge means is disposed in the recess, a end of the horizontal end of the body of the upturn hinge means is a hollow pipe for installing cables, it extends into a side wall of the recess to enable the hinge, the other end is tightly stick to the another side wall of the recess and the turning free end of the damper is received therein, the fixed end of the damper is secured to the rear portion of the side wall of the recess; the centre of the back wall of the upper surface of the main body has a upright hole, the vertical end of the body of the upturn hinge means is inserted into the upright hole.

The damper is of a key shape, of which the shaft head has a plurality of C-shape rub pieces with protruding ears at their periphery and these protruding ears are lined in a line forming a protruding ridge, the piece-shaped tail portion of the damper has a fixed hole; there is a slot set in the inside wall of the end of the horizontal end of the upturn hinge means for installing the damper, the head portion having rub pieces of the damper inserts into the above end of the upturn hinge means and the protruding ridge is stick to the said slot; a screw cross through the fixed hole in the end of the damper fixed the damper onto the back of side wall of the recess of the display cover board.

There is a locating tray at the interface of the vertical end and the horizontal end of the body of the upturn hinge means, the bottom of the locating tray lies on the shaft of the horizontal end, there in the outer side of the vertical end set two recesses which are symmetric to the shaft line of the vertical end, there are two bump pearl in the corresponding recesses on the two side of the upright hole of the upper surface of the main body.

On the outer circumference of the fix hole of the body of the upturn hinge means there is a locating protruding ear on the back side of the axes line of the horizontal end, there is a baffle plate on each side of the corresponding locating ear of the upper face of the main body.

There is a locating loop slot set around the outer circumference of the lower portion of the vertical end of the body of the upturn hinge means, the upper side wall of the locating loop slot parallel the lower end of the upright hole of the upper face of the main body, a flexible clip stick to the locating loop slot and withstand the lower end of the said upright hole.

There is a locating pole which extends downwards to limit the tuning range of the head of the flexible clip.

There is a baffle plate below the upright hole of the upper surface of the main body, a round-arc-like recess corresponding to the above upright hole is set on the baffle plate, the recess shelters a part of the edge of vertical end hole of the body of the upturn hinge means in the upright hole, a cable crosses through the lower portion of the recess mouth to the vertical end hole of the body of the upturn hinge means.

There is a recess in the centre of the front end of the display cover board, a two-way lock latch is disposed within the recess; there is a recess hole set in the centre of the front end of the main body, a button hook is fixed in the recess hole, the two-way lock latch and the button hook form a two-way locking means.

The two-way lock latch assumes rectangular board shape, its lower portion includes a rectangular open, its upper portion includes a short shaft and a ladder shaft both extend outwards from two sides, the ladder of the ladder shaft includes a pair of wedge mouth which is symmetry from up to down; there is another A-shaped locating block having a shaft hole in the upper portion sleeved on a thin shaft at the outer side of the wedge mouth of the ladder shaft, the waist of the locating block has a locating wedge extending to the wedge mouth of the ladder shaft, the outer side of the locating block on the thin shaft of the ladder shaft has a spring; button hook is a piece block whose cross section assumes an L-shape with the front end extending forwards forming a button and the rear end forming a button hook which is assorted with the open of the two-way lock and is formed of the upwards and backwards extending, the waist of the piece block extend from two side forming blocks, the rear side extends backwards forming two guide pole, there is a reposition spring on each pole; the button of the button-hook via the recess of the front end of the main body extend forwards; a end of the reposition spring withstand the back-end face of the button-hook, another end of the reposition spring withstand the support wall of the rear of the front end of the recess of the main body.

The invention of the portable player for videodisc with a screen which can rotate in upturn and/or turn around use T-branch pipe upturn hinge means to rotate the vertical axes and horizontal axes of the upper surface of the main body relative to the display cover board with display screen in the degree of 180 respectively, cables through the inter hole of the overturn pin joint connect to the main body and the display cover board, the integrate performance of the configure is good. The upturn hinge means pertains a damper, it can keep the display cover board in any pitching degree; and imposes a combination of the recess of the fix tray and the bump pearl, the combination of the locating protruding ear of the fix tray and the block limit the display cover board rotate in a degree of 180, prevent the cables from damage of the overage distort. Using the combination of locating loop slot and the flexible chip to avoid the up and down movement of upturn hinge means. Once the user select a certain point of view, the display cover board can stabilize in any space selected, especially for using in narrow space condition such as in cars, in trains or on ships, add the new funny of the journey. In particular, when the display cover board turn up to the display screen and use the two-way lock device lock tightly to the up face of the main body, the occupied space is small and the support of the display cover board is stabilize, this using state especially fit the situation of heavy jounce such as cars, trains.

### BRIEF DESCRIPTION OF THE DRAWINGS

The present invention will be described with greater specificity and detail through the use of the accompanying drawings, in which:

FIG. 1 is a solid structure view of the opening state of the circumrotate of display cover board having display screen rotating relatives to the horizontal axes of the upper face of the main body;

FIG. 2 is a solid structure view that shows the state of screen facing up and forwards after the respectively rotating of the display cover board along the vertical axes and the horizontal axes of the upper face of the main body;

FIG. 3 is a solid structure view that shows the state of screen facing up and backwards after the respectively rotating of the display cover board along the vertical axes and the horizontal axes of the up-face of the main body;

FIG. 4 is a solid structure view that show the state of screen to the upwards after the respectively rotate of the display cover board relative to the vertical axes and the horizontal axes of the upper face of the main body;

FIG. 5 is a solid structure view that shows the depositary state of the display cover board covering the upper face of the main body;

FIG. 6 is a deploy structure view of the two-way locking means;

FIG. 7 is a solid structure view of the damper.

FIG. 8 is a solid structure view of the upturn hinge means;

FIG. 9 is the state f FIG. 5, the transverse part section view of upturn hinge means to the horizontal axes;

FIG. 10 is the state of FIG. 5, the transverse part section view of upturn hinge means along the horizontal axes;

FIG. 11 is the solid structure view of the main body;

FIG. 12 is the part magnified view of the A section of FIG. 11;

FIG. 13 is the inside of the main body, the solid structure view of the hinge of the main body and the upturn hinge means;

FIG. 14 is a view of the interior of the main body, illustrating the solid structure figure of the cables guided into the upturn hinge means.

### DETAILED DESCRIPTION OF THE PREFERRED EMBODIMENTS

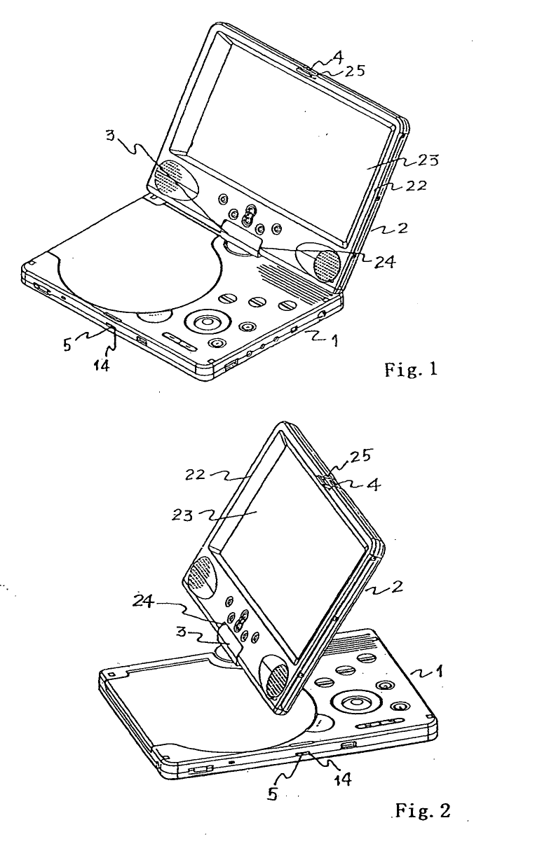

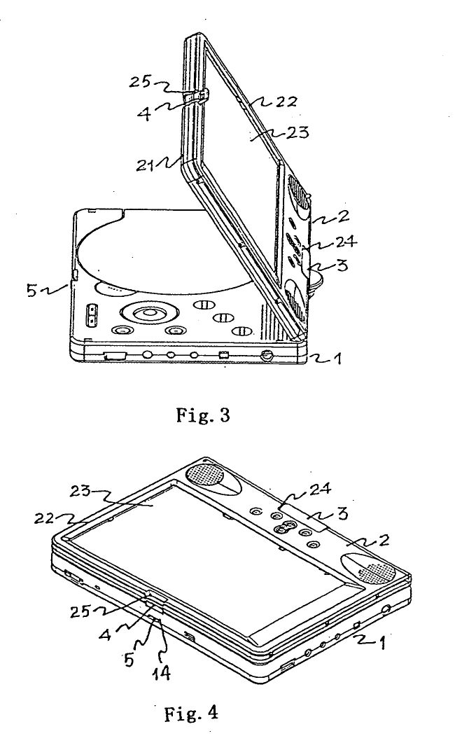

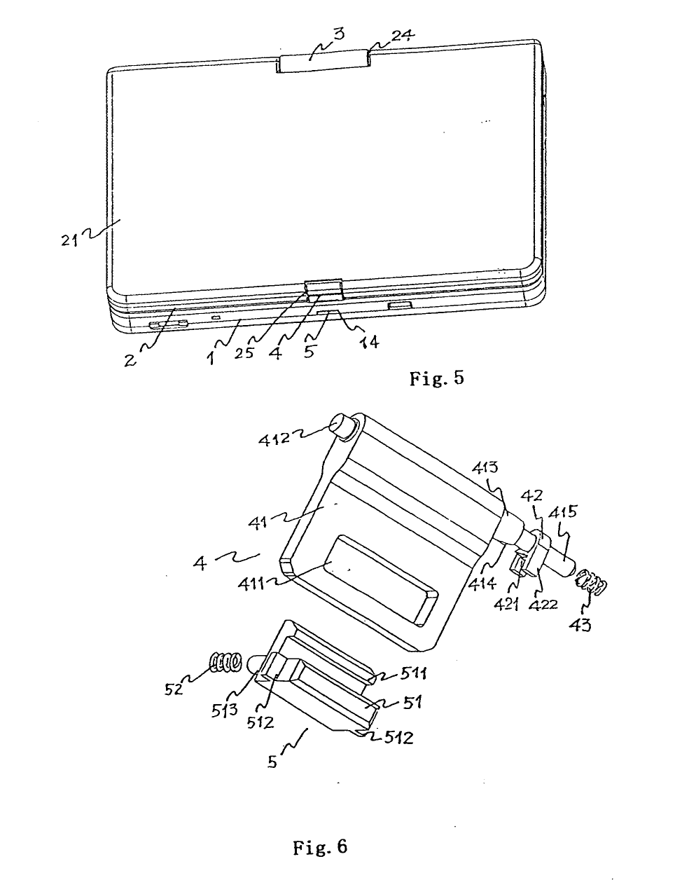

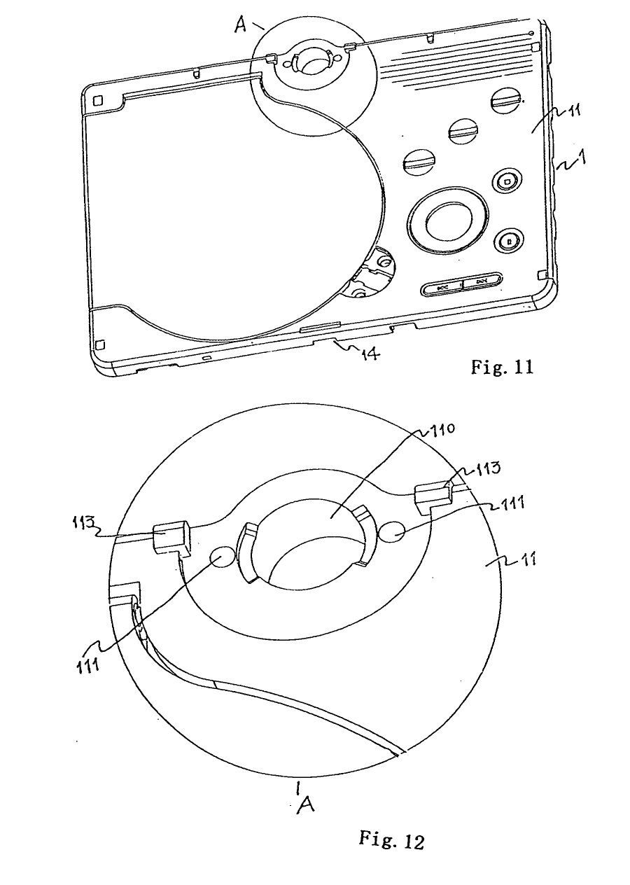

With reference through FIG. 1 to FIG. 5, an embodiment of a portable player for videodisc with a screen which can rotate in upturn and/or turn around of the present invention in upturning/rotating status are shown. The main body 1 and the display cover board 2 of the portable video disc player assume rectangular board shape. A disc driver means and a disc information read/processing means are installed inside the main body 1, and a disc can be disposed on the upper side of the main body 1 to be driven. The outer side of the display cover 2 is an outer protecting shell 21, the inner side of the display cover board 2 is a panel 22 in which a liquid crystal display screen 23 is installed. There is a recess 24 in the centre of the rear portion of the display cover board 2, the horizontal end of an upturn hinge means 3 is disposed within the recess 24. Referring to FIG. 11 and FIG. 12, there is an upright hole 110 in the centre of rear portion of the upper side of the main body, the vertical end of the upturn hinge means 3 is inserted into the upright hole 110. The main body of the upturn hinge means 3 is a T shaped cannula. The horizontal end 31 of the cannula is fixed on the side of the display cover board and is a shaft having a damper; the vertical end 32 is used as a rotation shaft which is mounted on the main body. A cable 5 across through the inner hole of the main body of the upturn hinge means 3 to make the main body 1 of the player and the display cover board 2 connected. When being pulled, the display cover board 3 can rotate within 180 degrees relatives to the vertical axes and the horizontal axes of its main body respectively, which enables a user to watch the disc player video programs at an optimum point. There is a recess 25 in the centre of the front end of the display cover board 3, a two-way lock latch 4 is disposed within the recess 25; there is a recess hole 14 set in the centre of the front end of the main body 1, a button hook 5 is fixed in the recess hole 14. The two-way lock latch 4 and the button hook 5 form a two-way locking means which makes the main body 1 and display cover board 2 be locked together as the state shown in FIG. 4 and FIG. 5.

Referring to FIG. 6, the body 41 of the two-way lock latch 4 assumes rectangular board shape, its lower portion includes a rectangular open 411, its upper portion includes a short shaft 421 and a ladder shaft 413 both extend outwards from two sides, the ladder of the ladder shaft 413 includes a pair of wedge mouth 414 which is symmetry from up to down; there is another A-shaped locating block 42 having a shaft hole in the upper portion sleeved on a thin shaft 415 at the outer side of the wedge mouth of the ladder shaft 413, the waist of the locating block has a locating wedge 421 extending to the wedge mouth 414 of the ladder shaft 413, the outer side of the locating block 42 on the thin shaft 415 of the ladder shaft 413 has a spring 43. Button hook is a piece block whose cross section assumes an L-shape with the front end extending forwards forming a button 51 and the rear end forming a button hook 511 which is assorted with the open 411 of the two-way lock 4 and is formed from the extend upwards and backwards reversal, the waist of the piece block extend from two side forming blocks 512, the rear side extends backwards forming two guide pole 513, there is a reposition spring 52 on each pole 513.

When installing, please refer to FIG. 1. The short shaft 412 of the two-way lock latch 4 is pivotably connected to a side of the recess 25 of the front end of the display cover board 2, the ladder shaft 413 of the two-way lock latch 4 is pivotably connected to the other side of the recess 25, and the two foots 422 of the locating block 42 is glidely inserted into the gliding slot at the rear side of the recess 25 (not shown in drawings). The button 51 of the button hook 51 extends forwards through the recess hole 14 of the front end of the main body 1; an end of the reposition spring withstands the rear end of the button hook 5, the other end withstands the support block of the rear of the recess hole 14 which is on the front end of the main body 1 (not shown in drawings). When used, the open 411 of the two-way lock latch is disposed in a lower position, and the display cover board 2 is turned to the main body 1, the under frame of the open 411 of the two-way lock latch 4 contact the button hook 511 of the button hook 5 and push the button hook 5 inwards, thus the reposition spring 52 is compressed; while the display cover board 2 totally covers the upper surface of the main body 1 and the buckle hook 511 of the button hook 5 lies in the open 411 of the two-way lock latch, the spring 52 withstands the button hook 5 so that the buckle hook 511 of the button hook 5 tightly buckle the open 411 of the two-way lock latch 4. In order to open the display cover board 2, first pressing the button 51 of the button hook 5 so that the reposition spring 52 is compressed, and then having the button hook 511 of the button hook 5 exit from the open 411 of the two-way lock latch, meanwhile upturning the display cover board 2. In the situation of opening the display cover board 2, turning the body 41 of the two-way lock latch 4, as a result, a bevel edge of the wedge mouth 414 of the ladder shaft 413 will push the locating wedge 421 of the locating block aside and make the locating block withdraw back, thus the spring 43 is compressed; after the locating wedge 421 totally exits from the wedge mouth 414 and when the two-way lock latch 4 turns to another wedge mouth 414 of the ladder shaft 413 of the locating wedge, under the action of the spring force of the spring 43, the locating block 42 moves close to the ladder shaft 413, the locating wedge 421 insert into the wedge mouth 414. When the locating wedge 421 totally insert into the wedge mouth 414, the two-way lock latch have turned over 180 degrees.

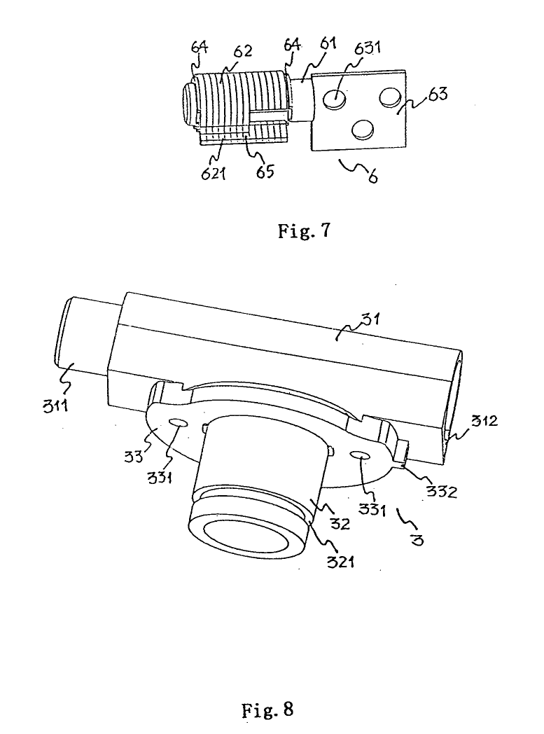

With reference to FIG. 7 of the structure of the damper 6, the damper is of a key shape with two flexible clip 64 respectively set at the two ends of the head of the bar portion. There is a plurality of C-shaped rub pieces with protruding ears 621 at their periphery between the two flexible clips. The protruding ears 621 of every rub piece 62 stand in a line forming a protruding ridge 65. The piece-liked tail portion 63 of the damper 6 includes three fixing holes 631 arranged in triangle.

The configuration of the upturn hinge means is shown FIG. 8. The main body of the upturn hinge means 3 is a T shaped cannula. The horizontal end 31 of the cannula extends aside and through an empty pipe shaft 311 which is used for receiving cable 7, the other end includes an insert slot 312 in the interior wall. The vertical end 32 of the upturn hinge means is used as a rotation shaft and a path for the cable 7, a limiting loop slot 321 is set at the periphery of the lower portion of the vertical end 32. There is a locating tray 33 at the interface of the vertical end 32 and the horizontal end 31 of the body of the upturn hinge means 3. The bottom of the locating tray 33 lies on the shaft of the horizontal end 31, the outside of the vertical end 32 set two recesses 331 which are symmetric to the shaft line of the vertical end 32, the outer periphery of the locating tray 33 lies on the rear side of the shaft of the cross shaft having a limiting protruding ear 332.

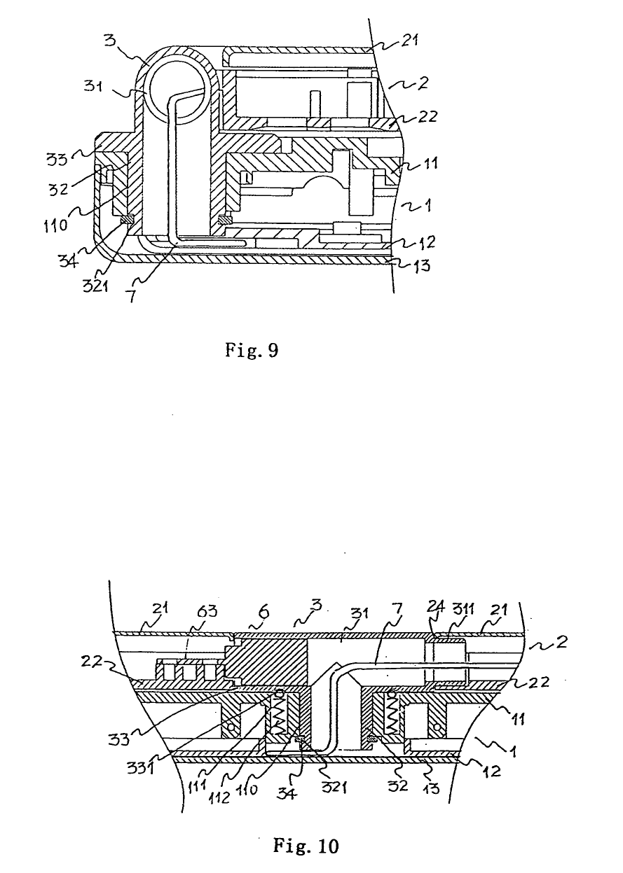

In order to specify the instance of the installment of the upturn hinge means 3 on the main body 1 and the display cover board 2, FIG. 9 and FIG. 10 present the two part section configuration of the state of the main body 1 and the display cover board in FIG. 5.

The outer shell of the main body 1 comprises the upper panel 11 and the bottom shell 13. With reference to FIG. 9 and FIG. 10, there is a upright hole 110 in the centre of the rear side of the upper panel of the main body 1, both sides of the upright hole 110 have a bump pearl hole 111 within which a bump pearl 112 comprising a small spring and a ball bearing is disposed; a block 13 is disposed at the slanting back of each of the two bump pearl hole 111 having a block 113. The vertical end 32 of the upturn hinge means is inserted into and located within the upright hole 110. The upper side wall of the limiting loop slot 321 of the vertical end 32 of the upturn hinge means 3 parallel the lower edge of the upright hole 110 of the upper panel of the main body 1, a flexible clip 34 is wedged into the limiting loop slot 321 and withstand the lower end face of the upright hole 110 to prevent the upturn hinge means 3 from gliding up and down relate to the main body 1. In order to prevent the head 341 of flexible clip 34 from expositing, as shown in FIG. 13, a limiting pole extending downwards is set on the two sides of the lower end face of the upright hole 110 to limit the running range of the flexible clip's 34 head 341. The two recessed 331 on the bottom of the locating tray 33 of the upturn hinge means 3 correspond to two bump pearl 112, when the rear edge of the main body 1 parallels the rear edge of the display cover board 2, the two bump pearl withstand into the corresponding recess 331, thus the location is fixed; the locating protruding ear 332 of the two locating tray 33 assort with the two block 113 to limit the upturn hinge means 3 to rotate along the vertical shaft of the upright hole 110 of the main body 1 within 180 degrees.

The outer shell comprises the outer protect shell 21 and a panel 22. There is a recess 24 in the center of the rear end of the display cover board 2, the horizontal end 31 of the upturn hinge means 3 is emplaced in the recess 24. The empty pipe shaft 311 extends into a side wall of the recess 24 and is clamped by the two semicircle arc slot of the inside of the panel22 and the outer protect shell 21, which accomplishes hinge connection. The end for installing the damper 6 on the horizontal end of the upturn hinge means 3 is tightly stick to the other side wall of the recess 24, the pipe hole is for receiving the free end of the damper 6, the fixed end of the damper 6 is secured to the rear portion of the side wall of the recess 24; in particular, the head 61 installed with the rub piece 62 of the damper 6 is inserted into the said end of upturn hinge means, and the protruding ridge is wedged into the insert slot 312 of the end head. The screw through the fix hole 631 of the tail 63 of the damper 6 fixes the damper 6 to the rear portion of the recess slot 24 of the display cover board 2.

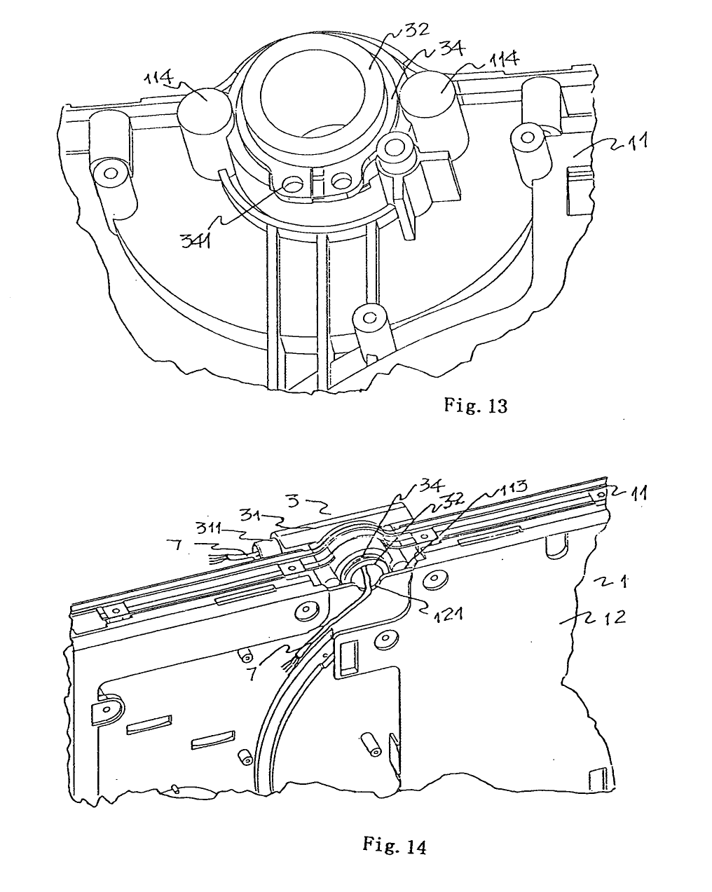

Cable 7 crosses through the vertical end 32 and horizontal end 31 of the upturn hinge means 3, which accomplishes the electric connection between the main body 1 an the display cover board 2. In order to avoid the abrasions caused by the friction between the cable 7 and the hole edge of the vertical 32 of the upturn hinge means, referring to FIG. 14, a circle recess 121 corresponding to the upright hole 110 is disposed on the lower baffle plate 12 of the interior of the main body 1 for sheltering the disc driver means and the disc information read/processing means, the recess 121 shelters the side edge of the vertical hole 32 of the upturn hinge means's body in the upright hole 110, the cable 7 crosses through the lower portion of the recess mouth 121 to the vertical end hole 32 of the body of the upturn hinge means, ensuring the center position not to touch the hole side edge of the vertical end 32.

### THE PRACTICABILITY OF THE INDUSTY

The invention provides a portable player for videodisc with a screen which can rotate in upturn and/or turn around, wherein a side edge of the main body and a side edge of the display cover board having upturn hinge means; the body of the upturn hinge means is a T shaped cannula, its crossing end is the overturn shaft having damper installed on the side of the display cover board, the vertical end is the turning shaft installing on the side of the main body; the display cover board with the display screen can respectively rotate 180 degrees roll with the axes of vertical end and crossing end of the upper surface of the main body, having favorable practicability.

The present invention may be embodied in other specific forms without departing from it sprit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A portable videodisc player with an upwardly and axially rotatable screen, comprising: a main body comprising a disc driver means and a disc information read/processing means and a display cover board with a display screen; an upturn hinge means is disposed at a side edge of the main body and a side edge of the display cover board; a cable connects the main body and the display cover board;
wherein the main body of the upturn hinge means is a T-shaped cannula, an end of a horizontal end of the cannula is a hollow pipe for accommodating cables, a hole in an opposite end accommodates a damper, forming a shaft with a damper, which is fixed on the side of the display cover board; a vertical end is used as a rotation shaft which is mounted on the main body; a cable passes through an inner hole of the main body of the upturn hinge means to connect the main body of the player and the display cover board; the display cover board is rotatable within 180 degrees relative to the respective vertical and horizontal axes of its main body.

2. The portable videodisc player of claim 1, further including recess in a center of a rear end of the display cover board; the horizontal end of the body of the upturn hinge means is disposed in the recess, an end of the horizontal end of the body of the upturn hinge means is a hollow pipe for accommodating cables, and extends into a side wall of the recess to enable the hinge, an opposite end is secured to another side wall of the recess and a turning free end of the damper is received therein, the fixed end of the damper is secured to a rear portion of the side wall of the recess; a center of the back wall of the upper surface of the main body has an upright hole, the vertical end of the body of the upturn hinge means is inserted into the upright hole.

3. The portable videodisc player of claim 2, wherein the damper is of a key shape, of which the shaft head has a plurality of C-shaped rub pieces with protruding ears at their periphery, said ears are disposed in a line forming a protruding ridge, a piece-shaped tail portion of the damper has a fixed hole; there is a slot set in an inside wall of the horizontal end of the upturn hinge means for installing the damper, said head having rub pieces of the damper inserts into the above end of the upturn hinge means and the protruding ridge is fastened to said slot; and the damper is fixed onto the back of side wall of the recess of the display cover board.

4. The portable videodisc player of claim 1 further including a locating tray at an interface of the vertical end and the horizontal end of the body of the upturn hinge means, the bottom of the locating tray lies on the shaft of the horizontal end, in the outer side of the vertical end are two recesses which are symmetric to the shaft line of the vertical end, two bump pearls are disposed in corresponding recesses on sides of an upright hole of an upper surface of the main body.

5. The portable videodisc player of claim 4, wherein on the outer circumference of the hole of the body of the upturn hinge means there is a locating protruding ear on the back side of the axis line of the horizontal end, a baffle plate is located on each side of the corresponding locating ear of the upper face of the main body.

6. The portable videodisc player of claim 1, wherein there is a locating loop slot set around an outer circumference of a lower portion of the vertical end of the body of the upturn hinge means, an upper side wall of the locating loop slot is parallel to the lower end of the upright hole of the upper face of the main body, a flexible clip is fastened to the locating loop slot and to the lower end of said upright hole.

7. The portable videodisc player of claim 6, wherein there is a locating pole which extends downwards to limit the turning range of a head of the flexible clip.

8. The portable videodisc player of claim 6, wherein there is a baffle plate below the upright hole of the upper surface of the main body, a round-arc-like recess corresponding to the above upright hole is set on the baffle plate, the recess shelters a part of the edge of vertical end hole of the body of the upturn hinge means in the upright hole, a cable crosses through the lower portion of a recess mouth to the vertical end hole of the body of the upturn hinge means.

9. The portable videodisc player of claim 1 further including a recess in a center of the front end of the display cover board, a two-way lock latch is disposed within the recess; a recess hole is set in a center of the front end of the main body, a button hook is fixed in the recess hole, the two-way lock latch and the button hook form a two-way locking means.

10. The portable videodisc player of claim 9, wherein the two-way lock latch assumes a rectangular board shape, its lower portion includes a rectangular opening, its upper portion includes a short shaft and a ladder shaft both extending outwards from two sides, a ladder of the ladder shaft includes a pair of vertically symmetrical wedge mouths; an A-shaped locating block having a shaft hole in an upper portion is sleeved on a thin shaft at an outer side of the wedge mouth of the ladder shaft, a waist of the locating block has a locating wedge extending to the wedge mouth of the ladder shaft, an outer side of the locating block on the thin shaft of the ladder shaft has a spring; the button hook is a piece block whose cross section assumes an L-shape with the front end extending forwards forming a button and the rear end forming a button hook which is engageable with an opening of the two-way lock and is formed of upwards and backwards extending portions, the waist of the piece block extends from two side forming blocks, a rear side extends backwards forming two guide poles, a reposition spring on each pole; the button of the button-hook extends forward via the recess of the front end of the main body is located; an end of the reposition spring engages the back-end face of the button-hook, another end of the reposition spring engages the support wall of the rear of the front end of the recess of the main body.
